(19) United States
(12) Patent Application Publication
(10) Pub. No.: US 2010/0266757 A1
(43) Pub. Date: Oct. 21, 2010

(54) Vehicle Glazing Panel Repair

(75) Inventors: André Segers, Lebbeke (BE); Christopher Davies, Carmarthenshire (GB)

Correspondence Address: GORDON & JACOBSON, P.C., 60 LONG RIDGE ROAD, SUITE 407, STAMFORD, CT, 06902, US

(73) Assignee: BELRON HUNGARY KFT - ZUG BRANCH, Zug (CH)

(21) Appl. No.: 12/601,879

(22) PCT Filed: Jul. 4, 2008
(86) PCT No.: PCT/GB2008/002326

§ 371 Date: Jun. 28, 2010

(30) Foreign Application Priority Data
Jul. 5, 2007 (GB) 0713040.4

(51) Int. Cl. B32B 43/00; B05C 21/00; B05D 3/04

(52) U.S. Cl. 427/140; 118/69; 427/398.1

(57) ABSTRACT

In hot ambient conditions (particularly in climates having strong sunshine) vehicle glazing panels can reach high temperatures frequently in excess of 50° C. and on occasions up to 90° C. plus. In such high temperature conditions it is a known problem that small glazing panel breaks or cracks can become elongated (or result in shattering of the glazing panel) when stresses are applied to the glazing panel. The invention provides a method of repairing a flaw (such as a crack or break) in a vehicle glazing panel by first, wetting the surface of the glazing panel in the vicinity of the flaw and then generating a forced air flow to enhance evaporation of the wetted glazing panel, and subsequently conduction a repair process on the flaw.

### BACKGROUND OF THE INVENTION

1. Field of the Invention

The present invention relates to vehicle glazing panel repair and cooling systems for vehicle glazing panels.

2. State of the Art

In hot ambient conditions (particularly in climates having strong sunshine) vehicle glazing panels can reach high temperatures frequently in excess of 50° C. and on occasions up to 90° C. plus. In such high temperature conditions it is a known problem that small glazing panel breaks or cracks can become elongated (or result in shattering of the glazing panel) when stresses are applied to the glazing panel. This phenomenon is known in the art as ‘cracking off’. Cracking off may occur when pressure or stresses are applied by crack or break repair devices which are mounted to the vehicle glazing panel to repair a crack or break in such hot ambient conditions. Such a device is disclosed in WO-A-0134373. The repair of what should have been a minor crack or break becomes, therefore, a more significant repair or requires the replacement of the whole glazing panel. This, in turn, becomes a more expensive and time-consuming operation. The industry-recommended temperature for conducting glazing panel repairs is between 10° C. and 29° C.

### SUMMARY OF THE INVENTION

An improved technique has now been devised for such situations. According to the invention, there is provided and a method for repairing a flaw (such as a crack or break) in a vehicle glazing panel, as well as apparatus for executing the method.

According to a first aspect, the invention provides a method of repairing a flaw (such as a crack or break) in a vehicle glazing panel the method comprising:
wetting the surface of the glazing panel in the vicinity of the flaw;
generating a forced air flow to enhance evaporation of the wetted glazing panel; and,
conducting a repair process on the flaw.

According to a second aspect, the invention provides, a repair system for a vehicle glazing panel, the repair system comprising:
an air flow arrangement for generating a forced air flow to enhance evaporation of a wetted glazing panel; and,
a repair arrangement for conducting a repair process on the flaw.

Beneficially, the air flow arrangement comprises a fan whish is preferably mounted to the vehicle glazing panel also beneficially adjustable in configuration and orientation.

A temperature-indicating device may be used for monitoring the surface temperature of a glazing panel. Adhesive tape may be used for covering the flaw to keep it dry during wetting and evaporation. An atomiser may be provided for producing a mist or spray of droplets to wet the surface of the glazing panel. The fan may be attached to one end of a flexible support, the other end being connected to, for example, a suction device such that the support (and thus the fan) can be secured to the glazing panel and the fan can be suspended at a desired height above the glazing panel surface.

The method preferably comprises checking the temperature of the glazing panel using a temperature-indicating device. The flaw is beneficially then covered so as to provide a barrier to exclude moisture. The fan is positioned above the area of the flaw and switched on. The area around the flaw is moistened typically by means of an atomiser spray of water) and dried by evaporation under the airflow of the fan. The temperature of the glazing panel is checked and (if necessary) the wetting and drying cycle is repeated until the temperature of the glazing panel is indicated as between 10° C. and 29° C. Surface moisture is removed and the flaw is uncovered. A repair process is then conducted on the flaw, typically involving infilling the flaw with a resin which hardens. This may be achieved using known apparatus such as vacuum repair apparatus as disclosed in WO-A-0134373.

The cooling fan may remain operational whilst the repair is being conducted and may be positioned to direct cooling air over the vacuum repair unit in position on the glazing panel.

Beneficially, the temperature indicating device is a thermometer, such as an infrared thermometer, which is positioned to target the surface of the glazing panel to indicate the local temperature of the flaw area prior to repair and to allow the temperature to be monitored during the repair process.

Beneficially, the glazing panel surface where the suction device is to adhere is cleaned prior to the application of the suction device to ensure that adequate suction will be achieved.

Beneficially, the suction device is secured to the glazing panel surface by means of a lever which can be raised or lowered to enhance or release the suction. Such a suction device is disclosed in, for example, GB-A-2430908.

Preferably, the fan is positioned approximately 15 cm above the surface of the glazing panel to permit the insertion of a repair device such as that disclosed in WO-A-0134373 between the glazing panel surface and the fan.

The fan may be connected to an external power source, and may be switched on or switched off while the repair device is in situ.

Preferably the glazing panel is sprayed with water, glass cleaner or other suitable liquid which has been passed through an atomiser, such as a spray bottle, to produce a mist.

It should be noted that the above-mentioned embodiments illustrate rather than limit the invention, and that those skilled in the art will be capable of designing many alternative embodiments without departing from the scope of the invention as defined by the appended claims.

In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumeration several means, several of these means may be embodied by one and the same item of hardware. The mere fact that certain measures are recited in mutually different dependent claims does not indicate that a combination of these measures cannot be used to advantage.

The invention will now be further described in specific embodiment by way of example only and with reference to the accompanying drawings.

### BRIEF DESCRIPTION OF THE DRAWINGS

FIG. 1 is a schematic perspective view of a repair system in accordance with the invention, for use in performance of the method of the invention.

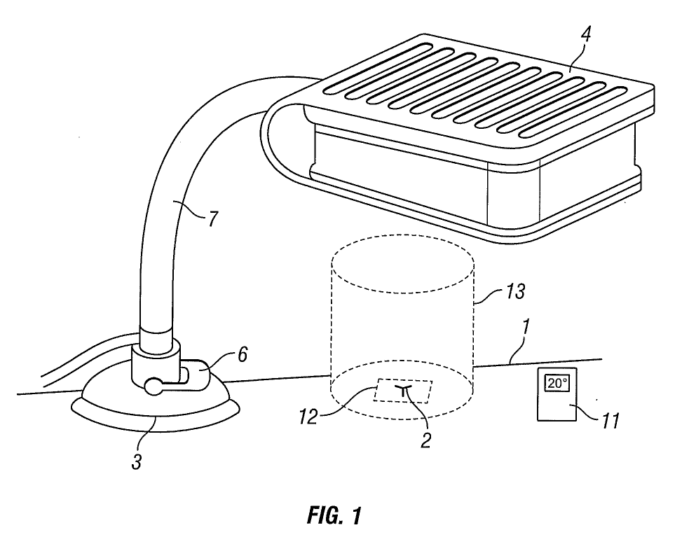

FIG. 2 is a flowchart outlining the method for cooling the glazing panel to the optimal repair temperature prior to conducting the repair.

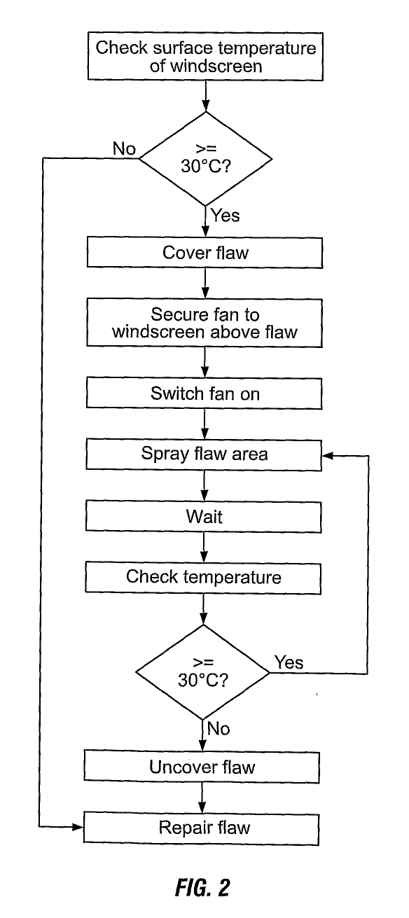

### DETAILED DESCRIPTION OF THE PREFERRED EMBODIMENTS

Referring to the drawings, the invention comprises apparatus for cooling a vehicle glazing panel prior to repairing a flaw (such as a crack or break). The apparatus comprises:
a temperature-indicating device (such as a digital thermometer 11) to enable a technician to check and monitor the surface temperature of the glazing panel;
a means (adhesive tape 12) of covering the flaw 2 to keep it dry during the cooling process;
a fan 4 for blowing air over the flaw area 2 of the glazing panel 1;
a means of anchoring and suspending/positioning the fan over the surface of the glazing panel, such as by use of a suction device 3 and bendable support arm 7;
a means of wetting the glazing panel surface, such as an atomiser or spray bottle filled with water or other suitable liquid; and
a vacuum repair device 13 (shown schematically only) such as is disclosed in WO-A-0134373.

The temperature-indicating device (such as an infrared digital thermometer 11) is used to target the surface of a vehicle glazing panel 1 so that the temperature of the glazing panel surface may be monitored during the cooling process. The flaw 2 is then covered so as to keep it dry, which is necessary for the subsequent repair to be successful. The application of adhesive tape 12 has been found to be suitable for such a task. The area of the glazing panel 1 where the suction device 3 will be applied is cleaned so as to facilitate optimal suction and the suction device 3 is secured to the glazing panel 1 by pulling down the lever 6 of the suction device 3. The fan 4 is then aligned over the flaw 2 at a height of approximately 15 cm from the flaw 2 (so as to enable the repair device 13 to be subsequently inserted between the glazing panel flaw 2 and the fan 4). The fan 4 is then switched on. The fan 4 may include a refrigerant heat exchanger in order to ensure that cooled air exits the downstream side of the fan.

The glazing panel area about the flaw is then wetted, for example by using an atomiser to spray water or alcohol droplets onto the area of glazing panel surrounding the flaw. A short period of time is allowed to elapse so that the moisture on the surface evaporates, absorbing heat from the air and glazing panel surface, and thus cooling it. The sprayed area may be several centimetres away from the flaw. Heat transfer from the flaw to the cooled area of the glazing panel will ensure sufficient cooling at the flaw.

The temperature of the surface is checked again, and if it is found to be above the optimum temperature range for repairs (i.e. it is not between 10° C. and 29° C.) the glazing panel 1 is re-sprayed. This process is repeated until the surface temperature is indicated as between 10° C. and 29° C. The surface of the glazing panel is then wiped to remove any residual moisture, and the adhesive tape is removed from the flaw 2. The repair is now conducted using resin and a vacuum repair device 13 such as is disclosed in WO-A-0134373. The cooling fan 4 may be operated during the repair in order to try and maintain the glazing panel at a cooler temperature.

Following successful completion of the repair, the fan 4 is removed from the glazing panel 1 by raising the lever 5, 6 on the suction device 3 to release the suction. The fan, bendable support and suction device can then be placed into a carry case along with the atomiser and thermometer. The sealed carry case is useful for keeping the fan, bendable support, suction device, thermometer and atomiser together so as to facilitate transportation and to prevent one of said items becoming lost.

It is important that the cooling process does not take a great deal of time, as the repair technician needs to move to new tasks as swiftly as possible. In experiments, it has been shown that the above method can cool the repair area of a glazing panel from 60° C. to between 20 ° C. and 25° C. (i.e. within the industry-recommended temperature range for repairs) within five minutes. Thus, the invention provides a method for cooling the glazing panel within an acceptably short period of time.

The invention has primarily been described in relation to cooling vehicle glazing panels. Those skilled in the art will appreciate, however, that the invention has application in other situations where the cooling of a surface or structure may be required.

1. A method of repairing a flaw in a vehicle glazing panel, comprising:
applying a fluid to a surface of the glazing panel at or adjacent the flaw;
generating a forced air flow about the glazing panel to enhance evaporation of the fluid about the glazing panel; and
conducting a repair process on the flaw.

2. A method according to claim 1, wherein:
the air flow is generated by a fan.

3. A method according to claim 1 further comprising:
cooling the airflow with a refrigeration apparatus.

4. A method according to claim 1 wherein:
the forced airflow is generated by a fan apparatus and the fan apparatus includes a refrigeration heat exchanger for cooling the air flow.

5. A method according to claim 2, further comprising:
positioning the fan above the flaw.

6. A method according to claim 5, wherein:
the fan is operational and remains in position above the flaw during at least a portion of the repair process.

7. A method according to claim 2, wherein:
the fan includes a fan mount.

8. A method according to claim 7, wherein:
the fan mount is adjustable to reorient the fan relative to the glazing panel.

9. A method according to claim 8, wherein:
the fan mount includes an adjustable arm for reorienting the fan relative to the glazing panel.

10. A method according to claim 7, wherein:
the fan mount includes a securing means for securing the fan to the vehicle glazing panel.

11. A method according to claim 10, wherein:
the securing means includes a suction mount device.

12. A method according to claim 1, further comprising:
positioning a protective covering over the flaw prior to applying the fluid to the surface of the glazing panel.

13. A method according to claim 12, wherein:
the protective covering includes adhesive tape.

14. A method according to claim 1 wherein:
applying the fluid to the surface of the glazing panel includes spraying the surface of the glazing panel with mist from an atomiser.

15. A method according to claim 1, wherein:
the fluid is water.

16. A method according to claim 1, further comprising:
checking the glazing panel surface temperature with a temperature indicating device.

17. A method according to claim 1, wherein:
conducting the repair process includes applying suction to the flaw.

18. A method according to claim 17, wherein:
the suction is applied during generation of the airflow.

19. A method according to claim 17, wherein:
the air flow is generated by a fan, and the fan remains secured to the glazing panel during the repair process and while the suction is applied to the flaw.

20. A repair system for use with a vehicle glazing panel having a flaw, the repair system comprising:
an air flow apparatus capable of generating a forced air flow about the glazing panel to cool the glazing panel; and
a repair apparatus for repairing the flaw.

21. A system according to claim 20, wherein:
the air flow apparatus includes a fan.

22. A system according to claim 20, further comprising:
a refrigeration apparatus for cooling the airflow generated by the airflow apparatus.

23. A system according to claim 21, wherein:
the fan includes a refrigeration heat exchanger to cool the air flow.

24. A system according to claim 20, wherein:
the airflow apparatus includes a mount for mounting the airflow apparatus to the glazing panel.

25. A system according to claim 24, wherein:
the mount is adjustable to reorient the air flow apparatus relative to the glazing panel.

26. A system according to claim 25, wherein:
the mount includes an arm which is adjustable to reorient the air flow apparatus relative to the glazing panel.

27. A system according to claim 24, wherein:
the mount includes securing means for securing the airflow apparatus to the vehicle glazing panel.

28. A system according to claim 27, wherein:
the securing means includes a suction device.

29. A system according to claim 20, further comprising:
means for applying a fluid to a surface of the glazing panel at or adjacent the flaw.

30. A system according to claim 20, wherein:
the repair apparatus is capable of applying suction to the flaw.

31. A method of cooling a vehicle glazing panel, comprising:
applying a fluid to a surface of the glazing panel; and
generating a forced air flow with a fan mounted to the vehicle glazing panel to enhance evaporation of the fluid about the wetted glazing panel.
